(19) United States
(12) Patent Application Publication
(10) Pub. No.: US 2008/0278629 A1
(43) Pub. Date: Nov. 13, 2008

(54) IMAGE QUALITY ADJUSTMENT DEVICE AND IMAGE QUALITY ADJUSTMENT METHOD

(75) Inventors: Satoshi YAMADA, Osaka (JP); Yasunori YAMAMOTO, Osaka (JP); Tetsuya YOSHIZAKI, Osaka (JP); Junichi TERAI, Hyougo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/113,343

(22) Filed: May 1, 2008

(30) Foreign Application Priority Data
May 9, 2007 (JP) 2007-124998
Apr. 15, 2008 (JP) 2008-106222

(51) Int. Cl. H04N 5/45; H04N 5/14; G06K 9/40

(52) U.S. Cl. 348/565; 382/254; 348/718; 348/E05.112

(57) ABSTRACT

The present invention provides an image quality adjustment device capable of generating an image of a highest image quality for an input image. The image quality adjustment device which adjusts image quality of an input image by applying different image quality settings to the input image includes: pieces of order information each of which indicates an order for applying plural image quality settings, a selection unit which selects optimal order information having a maximum evaluation value, and an adjustment unit which adjusts an image quality of input image based on the optimal order information.

### BACKGROUND OF THE INVENTION

(1) Field of the Invention

The present invention relates to an image quality adjustment device which performs an image quality adjustment to an input image by applying plural different image quality settings, and an image quality adjustment method.

(2) Description of the Related Art

In recent years, the technology for large, high-definition screens for Liquid Crystal Display televisions and plasma televisions have been improved, and there has been a rising demand for a device capable of reproducing video of higher image quality.

Under such a circumstance, there has been a video reproduction device which reproduces various videos such as videos distributed via the Internet, high-definition videos recorded in a Blu-ray Disc (BD) and a High-Definition Digital Versatile Disc (HD-DVD), in addition to conventional videos taken in the VHS and recorded in a DVD. Here, a predetermined image quality adjustment is often performed to an input image using an image quality adjustment device provided in the video reproduction apparatus.

In such a case, a user sets various parameters regarding image quality in order to obtain an image of higher image quality. As for parameters regarding image quality, there are a tremendous number of parameters such as brightness, chromaticness, color balance, contrast, gamma, sharpness, Under Color Removal (UCR), the number of screen lines, and noise removal. The image quality adjustment device sequentially applies, to an input image, each of image quality settings based on each of the parameters that are set, and outputs an adjusted image. Here, the image quality setting represents a modification of image quality of the input image according to the set parameter.

The setting of the parameters is complicated and cumbersome for an average user since the required operations are extremely confusing. Thus, a technology disclosed in Patent Reference 1: Japanese Unexamined Patent Application Publication 2006-234869 has been proposed. The image quality adjustment device shown in Patent Reference 1 automatically sets each parameter, sets the image quality based on each of the parameters, and outputs an adjusted image. With this, it is not necessary for the user to perform complicated parameter setting, and thus an image of high image quality can be automatically generated.

### SUMMARY OF THE INVENTION

The present invention has been conceived in view of the above problem, and an object of the present invention is to provide an image quality adjustment device capable of generating an image of the highest image quality for an input image and an image quality adjustment method.

In order to achieve the object above, the image quality adjustment device according to the present invention is an image quality adjustment device which adjusts image quality of an input image by applying different image quality settings to the input image, the image quality adjustment device including: a management unit which obtains and manages pieces of order information each of which indicates an application order of the image quality settings, and evaluation values each of which corresponds to each piece of the order information and represents adequacy of the order; a selection unit which selects a piece of optimal order information which has a maximum evaluation value from among the pieces of order information; and an adjustment unit which adjusts the image quality of the input image based on the optimal order information.

With this configuration, it is possible to generate an image of the highest image quality for an input image by adjusting the image quality in an optimal order.

In addition, the selection unit may further perform an order selection process, prior to selecting the optimal order information, for selecting a piece of order information to which one of the evaluation values is not associated, the adjustment unit may adjust the image quality of the input image based on the selected order information, the image quality adjustment device may further include an evaluation unit which evaluates an adjusted image generated by adjusting the image quality by the adjustment unit, and the management unit may obtain a result of the evaluation by the evaluation unit and manages the result of the evaluation as the evaluation value. In addition, the selection unit may perform the order selection process until evaluation values corresponding to all of the order information are obtained.

With this configuration, it is possible to use the evaluation value of the input image for determining the optimal order, and the image of the highest image quality can be generated.

In addition, the selection unit may perform the order selection process until evaluation values corresponding to all of the order information are obtained.

With this configuration, process amount for adjusting image quality can be reduced.

In addition, the image quality adjustment device may further include a termination instruction unit which outputs a termination instruction to terminate the order selection process to the selection unit, in which the selection unit terminates the order selection process in response to the termination instruction and selects the optimal order information from among the order information that has been obtained at the time of termination.

With this configuration, the image quality adjustment can be terminated for images to which improvement on the image quality is not required, and thus the process amount for adjusting image quality can be reduced.

In addition, the termination instruction unit may output the termination instruction based on a setting of software or an external terminal.

With this configuration, the termination instruction can be determined by the setting in the software or the external terminal, and thus the process amount for adjusting the image quality can be reduced.

In addition, the termination instruction unit may output the termination instruction to the selection unit when an evaluation value of the adjusted image is inputted from the evaluation unit and the evaluation value exceeds a predetermined threshold. In addition, the termination instruction unit may output the termination instruction to the selection unit when an evaluation value of the adjusted image is inputted from the evaluation unit and the evaluation value exceeds a predetermined threshold.

With this configuration, the termination instruction can be determined based on the evaluation value of the input image, and it is possible to terminate the adjustment process when an image adjusted to a sufficient image quality is generated. Thus, process amount for adjusting image quality can be reduced.

In addition, the termination instruction unit may output the termination instruction to the selection unit based on decoder input information inputted from a decoder. Furthermore, the decoder input information may be one of special reproduction information, chapter start information, and code amount information.

With this configuration, the termination instruction can be determined based on the decoder input information inputted from the decoder, and the process amount for unnecessary image quality adjustment can be reduced.

In addition, the evaluation unit may evaluate a reduced image of the adjusted image. In addition, the evaluation unit may evaluate a clipped image which is an image partially clipped from the adjusted image.

With this configuration, the image data amount to be evaluated can be reduced, and thus the process amount for evaluating image quality can be reduced.

In addition, the evaluation unit may switch a first evaluation method and a second evaluation method which respectively have different levels of evaluation accuracy and to evaluate an image.

With this configuration, the process amount for evaluating image quality can be reduced.

In addition, the management unit may store, for each piece of the order information, a selection flag which indicates whether or not the order information is to be selected by the selection unit, and the selection unit may select a piece of the order information based on the selection flag.

With this configuration, by specifying the order information to be selected, unnecessary selection is not performed, and process amount for adjusting image quality can be reduced.

In addition, the input image may include a first input image and a second input image, the image quality adjustment device may further include a similarity judging unit which judges a similarity between an evaluation value of the first input image and at least one of evaluation values of the second input image, and output, when the similarity is identified, order sharing information which indicates that the order information can be shared, and the management unit may associate the evaluation value of the first input image with the evaluation value of the second input image when the order sharing information is inputted. In addition, the input image may include a first input image and a second input image, the image quality adjustment device may further include a similarity judging unit which judges a similarity between an evaluation value of the first input image and at least one of evaluation values of the second input image, and outputs when the similarity is identified, order sharing information which indicates that order information can be shared, and the selection unit may select optimal order information for the first input image based on the order sharing information when adjusting the image quality of the second input image.

With this configuration, when a similarity is detected among the image quality evaluation values of plural input images, process amount for adjusting image quality can be reduced by sharing the order information.

In addition, the image quality adjustment device may further include a size comparison unit which compares sizes of two input images, and determines an image which is smaller in size as the first input image and an image which is larger in size as the second input image, in which the selection unit may further perform the order selection process for the first input image, and not perform the order selection process for the second input image. In addition, the image quality adjustment device may further include a picture-in-picture judging unit which detects a picture-in-picture image, and determines an inset image of the picture-in-picture image as the first input image and an outer image of the picture-in-picture image as the second input image, in which the selection unit performs the order selection process for the first input image, and does not perform the order selection process for the second input image.

With this configuration, the image quality can be preferentially adjusted for an image with less data, and the process amount for adjusting image quality can be reduced.

In addition, the video reproduction apparatus according to the present invention is a video reproduction apparatus which includes the image quality adjustment device and a storage device in which image data is stored, and the image quality adjustment device adjusts image quality of an input image inputted from the storage device by applying different image quality settings to the input image, the video reproduction apparatus includes: a data storage unit operable to store a flag which indicates whether optimal order information used in a previous reproduction is valid or invalid and the optimal order information; a writing information holding unit operable to hold the optimal order information notified by the selection unit; and a writing control unit operable to control the writing information holding unit to store the content held by the writing information holding unit and the flag in a predetermined location in the data storage unit when the content held by the writing information holding unit reaches a predetermined amount.

In addition, the video reproduction device may further include: a flag judging unit which reads out the flag from the data storage unit and judges whether the flag is valid or invalid; and a readout control unit which receives a result of the judgment by the flag judging unit, and reads out the optimal order information from the data storage unit when the flag is valid. In addition, the data storage unit may be included in the storage device and may store the flag and the optimal order information in association with a reproduced image, and the flag judging unit may read out the flag corresponding to the image being reproduced when reproducing a new image, and to judge whether the flag is valid or invalid.

With this configuration, it is possible to reduce process amount for adjusting image quality at a next output by storing the input image having a determined image quality adjustment order and corresponding optimal order information, and using the stored optimal order information at the next image output.

In addition, the data storage unit may further store synchronization information which indicates the optimal order information is to be synchronized with the image, and the readout control unit may further read out the optimal order information while synchronizing the optimal order information to the input image inputted to the image quality adjustment device based on the synchronization information.

With this configuration, it is possible to reduce process amount for adjusting image quality at the second image output by storing the input image with a fixed image quality adjustment order and the optimal order information in a storage device, and adjusting image quality using the optimal order information in synchronization with the image.

In addition, the image quality adjustment device according to the present invention can be realized, not only as a device, but also as an image quality adjustment method including the process units configuring the device as steps, as a program which causes a computer to execute the steps, and a computer-readable recording medium such as CD-ROM on which the program is recorded.

With the image quality adjustment device according to the present invention, an image of the highest image quality for an input image can be generated.

### FURTHER INFORMATION ABOUT TECHNICAL BACKGROUND TO THIS APPLICATION

The disclosure of Japanese Patent Application No. 2007-124998 filed on May 9, 2007 and Japanese Patent Application No. 2008-106222 filed on Apr. 15, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing an image quality adjustment device according to the first embodiment of the present invention;

FIG. 2A is a chart showing an example of the management information;

FIG. 2B is a chart showing an example of the management information;

FIG. 3 is a flowchart showing the operations of the image quality adjustment device according to the first embodiment of the present invention;

FIG. 4 is a block diagram showing an image quality adjustment device according to the second embodiment of the present invention;

FIG. 5A is a block diagram showing a specific example of the determination unit included in the image quality adjustment device of the present invention;

FIG. 5B is a block diagram showing a specific example of the determination unit included in the image quality adjustment device of the present invention;

FIG. 5C is a block diagram showing a specific example of the determination unit included in the image quality adjustment device of the present invention;

FIG. 5D is a block diagram showing a specific example of the determination unit included in the image quality adjustment device of the present invention;

FIG. 5E is a block diagram showing a specific example of the determination unit included in the image quality adjustment device of the present invention;

FIG. 6 is a block diagram showing an image quality adjustment device according to the third embodiment of the present invention;

FIG. 7 is a block diagram showing an image quality adjustment device according to the fourth embodiment of the present invention;

FIG. 8A is a block diagram showing a specific example of the evaluation control unit included in the image quality adjustment device of the present invention;

FIG. 8B is a block diagram showing a specific example of the evaluation control unit included in the image quality adjustment device of the present invention;

FIG. 8C is a block diagram showing a specific example of the evaluation control unit included in the image quality adjustment device of the present invention;

FIG. 9 is a block diagram showing an image quality adjustment device according to the fifth embodiment of the present invention;

FIG. 10 is a flowchart showing the operations of the image quality adjustment device according to the fifth embodiment of the present invention;

FIG. 11 is a block diagram showing an image quality adjustment device according to the fifth embodiment of the present invention;

FIG. 12 is a block diagram showing an image quality adjustment device according to the fifth embodiment of the present invention;

FIG. 13 is a block diagram showing a video reproduction apparatus according to the sixth embodiment of the present invention;

FIG. 14A is a flowchart showing the operations of the video reproduction apparatus when the image is reproduced for the first time according to the sixth embodiment of the present invention;

FIG. 14B is a flowchart showing the operations of the video reproduction apparatus when the image is reproduced next time according to the sixth embodiment of the present invention;

FIG. 15 is a block diagram showing another example of video reproduction apparatus according to the sixth embodiment of the present invention; and

FIG. 16 is a diagram showing an example of the respective information in the sixth embodiment.

### DESCRIPTION OF THE PREFERRED EMBODIMENTS

An image quality adjustment device according to the present invention will be described hereinafter with reference to the drawings. Since the same reference numerals are given to the same components, the descriptions for these components are omitted in some cases.

### First Embodiment

The image quality adjustment device according to the first embodiment is an image quality adjustment device capable of generating an image of the highest quality by adjusting image quality of the input image in an optimal order.

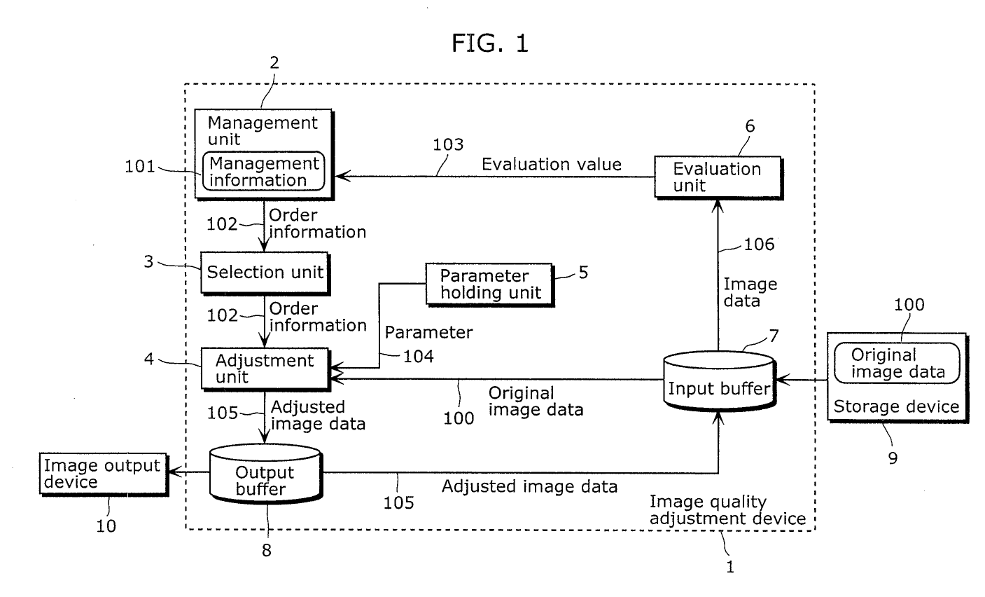

FIG. 1 is a block diagram showing the image quality adjustment device according to the first embodiment of the present invention; The image quality adjustment device 1 in FIG. 1 includes a management unit 2, a selection unit 3, an adjustment unit 4, a parameter holding unit 5, an evaluation unit 6, an input buffer 7, and an output buffer 8.

The management unit 2 obtains and manages the management information 101.

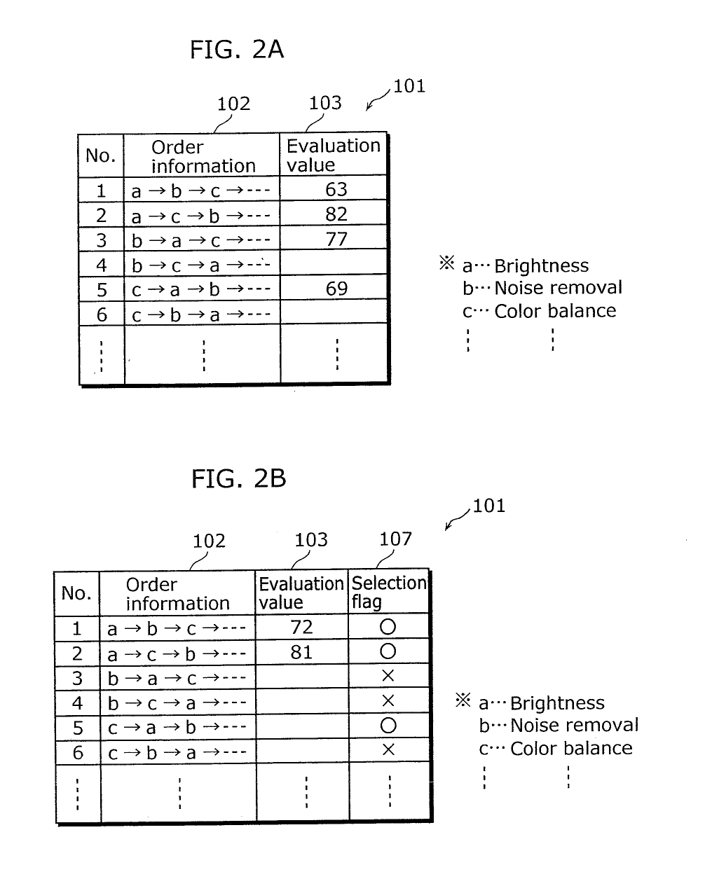

The management information 101 is information including the pieces of order information 102 and an associated evaluation value 103 of adjusted image data obtained through an image adjustment based on each of the order information. FIG. 2A and FIG. 2B shows an example of the management information 101.

The order information 102 is information which indicates an order for applying image quality settings. Here, the image quality setting represents modification of image quality of the input image according to the parameter that is set. When the image quality settings which are to be applied for the images include an irreversible image quality setting and when the order of image quality settings is different, different pieces of adjusted image data are obtained depending on the orders.

The evaluation value 103 is an evaluation value of the adjusted image data, and it represents a comprehensive image quality to human eyes in balance with human senses using evaluation items such as graininess, sharpness, tonal characteristics, and color reproducibility. Details are described in Patent Reference 1.

The selection unit 3 selects optimal order information with the maximum evaluation value when the evaluation value 103 is obtained for all the pieces of order information 102 in the management information 101. When there is order information without an evaluation value 103 in the management information 101, the selection unit 3 selects a piece of order information without an evaluation value.

The adjustment unit 4 obtains a parameter 104 necessary for image quality setting from the parameter holding unit 5 based on the order information 102 selected by the selection unit 3, and adjust image quality of the original image data 100 from the input buffer 7. In the first embodiment, image quality adjustment indicates execution of the image quality settings in a predetermined order.

The parameter holding unit 5 holds plural parameters 104 each corresponding to each of different image quality settings. Here, the parameter 104 is automatically set by an operation by a user or the technology disclosed in Patent Reference 1.

Parameter 104 includes parameters corresponding to difference settings such as brightness, chromaticness, color balance, contrast, gamma, sharpness, Under Color Removal (UCR), the number of screen lines, and noise removal.

The evaluation unit 6 evaluates the image quality of the adjusted image data 105 obtained through an image quality adjustment performed by the adjustment unit 4. The evaluation value 103 obtained by evaluating the image quality is outputted to the management unit 2.

The input buffer 7 stores original image data 100 obtained from the storage device 9.

The output buffer 8 stores the adjusted image data 105 outputted from the adjustment unit 4.

The management unit 2, the selection unit 3, the adjustment unit 4, and the evaluation unit 6 are usually configured of Micro Processing Unit (MPU) and memory and the like. The processing order of each unit is implemented by software, and the software is recorded in the recording medium such as Read Only Memory (ROM). Furthermore, each unit may also be configured of hardware (a dedicated circuit).

Nonvolatile recording medium is suitable for the parameter holding unit 5, the input buffer 7 and the output buffer 8; however, a volatile recording medium may also be used to implement the components.

Here, the following shows an example in which different evaluation values 103 of the adjusted image data 105 are obtained when the order of image quality settings performed by the adjustment unit 4 is different.

For example, a case where the order information 102 includes noise removal and edge enhancement, and an image inputted from the input buffer 7 has clear edges and includes noises to be removed is described. The image having clear edges and noises to be removed is, for example, an animation image or Computer Graphics (CG).

Here, when the edge enhancement is performed before the noise removal, there is a possibility that noise is detected by mistake when detecting a contour to which the edge enhancement is performed. Thus, the image quality may be worse by detecting the noise as a contour and enhancing the detected noise. To put it differently, the evaluation value 103 decreases.

On the contrary, when noise removal is performed before the edge enhancement, the noise is not enhanced since the noise has already been removed when detecting the contour. Thus, the image quality is improved and the evaluation value 103 increases.

Note that these are just an example and the values of the evaluation value 103 are approximately identical regardless of the order of image quality setting when it is difficult to distinguish an image from a noise such as a landscape photograph.

As described above, there are cases that different evaluation values 103 are obtained depending on the order of image quality setting. According to the image quality adjustment device of the first embodiment, an image of the highest image quality can be generated by selecting an optimal order for the image quality setting.

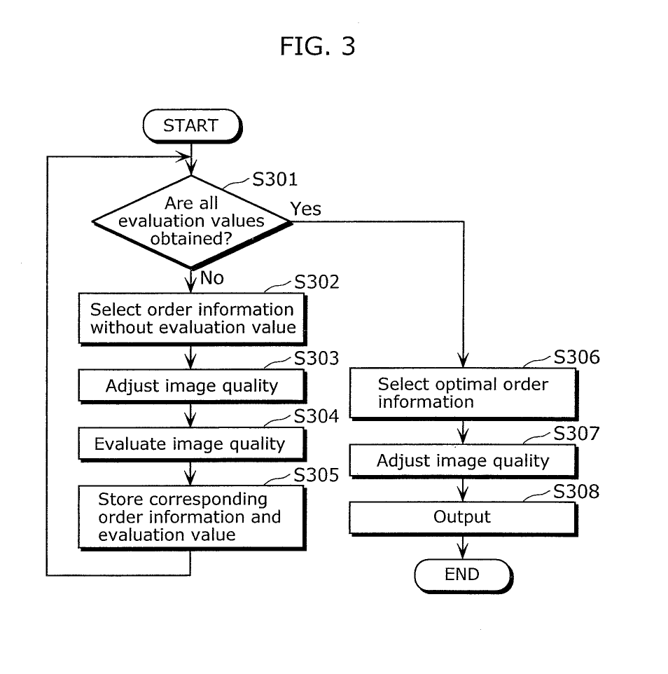

Next the operation of the image quality adjustment device is described with reference to the flowchart shown in FIG. 3.

The selection unit 3 judges whether or not the evaluation value 103 is obtained for all of the order information 102 in the management information 101 stored in the management unit 2 (S301).

When the evaluation values 103 are not obtained for all order information 102 (No in S301), the selection unit 3 performs order selection process (S302). In the order selection process, the selection unit 3 selects one piece of the order information 102 without the evaluation value 103 from among the management information 101 stored in the management unit 2, and outputs the selected order information 102 to the adjustment unit 4. The adjustment unit 4 obtains the parameter 104 from the parameter holding unit 5 based on the order information 102. Image quality of the original image data 100 inputted from the storage device 9 via the input buffer 7 is adjusted, and the adjusted image data 105 is stored in the output buffer 8 (S303).

The evaluation unit 6 obtains the adjusted image data 105 from the output buffer 8 via the input buffer 7, evaluates the image quality of the adjusted image data which is obtained, and outputs the evaluation value 103 to the management unit 2 (S304).

The image quality is evaluated as follows. First, the image quality is evaluated for each characteristic using evaluation functions for evaluating items such as graininess, sharpness, tonal characteristics, and color reproducibility. Next, the evaluation value 103 is calculated which represents comprehensive image quality to human eyes in balance with human senses using the evaluation result of each item. Details are described in Patent Reference 1.

The management unit 2 stores the management information 101 which includes the order information 102 and the evaluation value 103 inputted from the evaluation unit 6 that correspond with each other (S305). When the evaluation value 103 is newly added to the management information 101, the process returns to the judgment of the evaluation value (S301), and process from selecting the order (S302) to storing management information (S305) are repeated until all evaluation values 103 are obtained.

When all the evaluation values 103 are obtained for all order information 102 (Yes in S301), the selection unit 3 selects optimal order information with the maximum evaluation value from among the obtained evaluation values 103, and outputs the selected optimal order information to the adjustment unit 4 (S306). Here, when there are plural pieces of optimal order information, one piece of the optimal order information is selected. Furthermore, the adjustment unit 4 adjusts image quality based on the optimal order information (S307), and outputs the adjusted image data 105 to the image output device 10 via the output buffer 8 (S308).

As described above, the image quality of the input image can be adjusted in an order allowing the image of the highest image quality for the input image is generated.

Note that in the first embodiment, the order selection, the image quality adjustment and the evaluation is performed until the evaluation value is obtained for all order information, however, it is not necessary to perform the process for all order information, and the order information to be selected may be limited by the setting in advance.

For example, in order to limit the order information to be selected, the selection flag 107 may be stored corresponding to the order information 102.

The selection flag 107 is a flag which indicates whether the corresponding order information is to be selected by the selection unit 3. As shown in FIG. 2B, only the order information includes valid selection flag (circles in FIG. 2B) is to be processed in the order selection by the selection unit 3.

In addition, in the first embodiment, the evaluation unit 6 evaluates the image quality of the adjusted image data 105, whereas the evaluation unit 6 may evaluate the image quality of the original image data 100 and store the evaluation value 103.

With this configuration, the evaluation value of the original image data may be stored, and it is possible to calculate the degree of improvement of the adjusted image data in image quality compared to the original image data.

### Second Embodiment

The image quality adjustment device according to the second embodiment is configured to limit the order selection process shown in the first embodiment to the minimum to reduce the process amount. More specifically, while the image quality adjustment device according to the first embodiment performs image quality adjustment process until all the evaluation values corresponding to all order information to be processed by the order selection process, the image quality adjustment device according to the second embodiment is capable of generating an image of high image quality without necessarily obtaining all evaluation values.

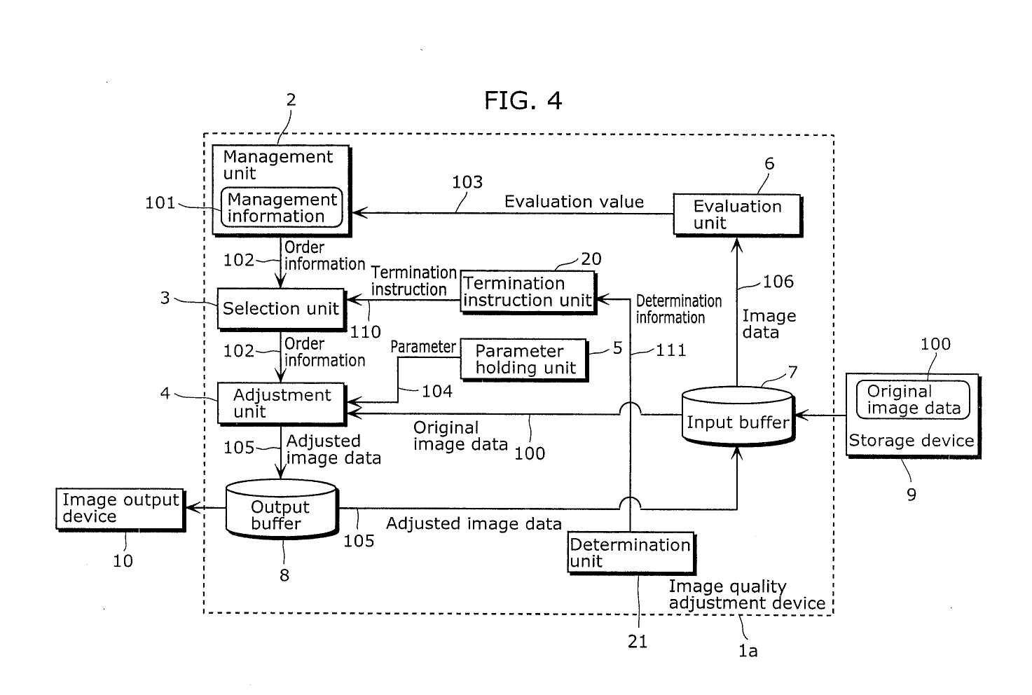

FIG. 4 is a block diagram showing the image quality adjustment device 1a according to the second embodiment. The configuration shown in FIG. 4 is different from the configuration shown in FIG. 1 in that a termination instruction unit 20 and a determination unit 21 are added. Hereinafter, the description for the same components is omitted, and the description will be made focusing on the difference.

The termination instruction unit 20 outputs the termination instruction 110 which instructs the termination of process selecting the order information 102 from the management information 101. The termination instruction 110 is created based on the determination information 111 which indicates availability of termination.

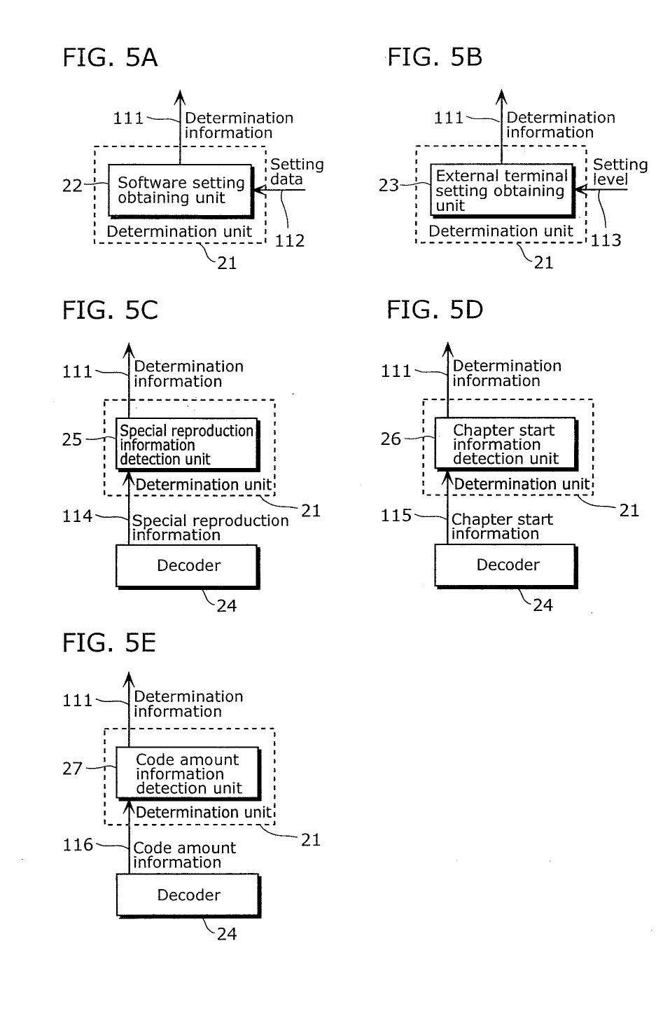

The determination unit 21 includes a software setting obtaining unit 22 as shown in FIG. 5A. The software setting obtaining unit 22 obtains setting data 112 which indicates availability of termination by the software, and outputs the determination information 111 to the termination instruction unit 20 based on the setting data 112.

The selection unit 3 terminates selection of the order information 102 when the termination instruction 110 is inputted, and selects the order information with the maximum evaluation value from among the order information having the evaluation values at the time of termination as optimal order information, and outputs the selected optimal order information to the adjustment unit 4.

The termination instruction unit 20 and the determination unit 21 are usually configured of MPU, memory or the like. The processing order of each unit is implemented by software, and the software is recorded in a recording medium such as ROM. Furthermore, each unit may also be configured of hardware (a dedicated circuit).

Next, operations of the image quality adjustment device according to the second embodiment are described.

The determination unit 21 outputs the determination information 111 based on the setting of the software to the termination instruction unit 20 prior to or during the operation of the image quality adjustment device 1a. The termination instruction unit 20 outputs the termination instruction 110 based on the determination information 111 to the selection unit 3.

When starting the image quality adjustment process, in the case where the termination instruction 110 has already been inputted to the selection unit 3, the image quality adjustment device 1a according to the present invention does not perform the processes from the judging of evaluation value (S301) to the storing of management information (S305), and performs the processes from the selection of the optimal order information (S306) to the output of the adjusted image (S308). When selecting the optimal order information (S306), and in the case where the optimal order information cannot be selected since no evaluation value has been obtained, the selection unit 3 selects one piece of order information from among the pieces of order information.

While the image quality adjustment device 1a performs the image quality adjustment process (S301 to S305) shown in the flowchart in FIG. 3, the selection unit 3 terminates a selection of the order information 102 when the termination instruction 110 is inputted, selects the order information with the maximum evaluation value from among the order information having the evaluation values at the time of termination as the optimal order information, and outputs the selected optimal order information to the adjustment unit 4. Here, when there are pieces of optimal order information, one of the optimal order information is selected. In addition, when there is no optimal order information, one piece of the order information 102 in the management information 101 is selected.

The adjustment unit 4 adjusts image quality of the original image data 100 based on the optimal order information, and outputs the adjusted image data 105 to the image output device 10 via the output buffer 8.

As described above, according to the second embodiment, for images to which improvement on the image quality is not required, unnecessary process for the image quality adjustment can be reduced by outputting the termination instruction 110 to the selection unit 3 by the software setting.

Note that the software is programmed to determine the determination information 111 which indicates availability of termination under various conditions. For example, the program may be set that the process is terminated when the time taken for image quality adjustment exceeds a predetermined amount of time.

In addition, as shown in FIG. 5B, the determination unit 21 may include an external terminal setting obtaining unit 23. The external terminal setting obtaining unit 23 obtains a setting level 113 of the external device, and outputs the determination information 111 to the termination instruction unit 20 based on the setting level 113.

With this configuration, unnecessary process for adjusting the image quality can be reduced by terminating the order selection process based on the setting of the external terminal, instead of the setting in the software.

In addition, FIGS. 5C to 5E are diagrams showing specific examples of the determination unit 21. The determination unit 21 may be configured to determine the determination information 111 based on the decoder input information inputted from an external decoder 24. Here, the decoder 24 is a device for, for example, decoding coded image data in the storage device 9, and outputting the decoded data to the image quality adjustment device 1a.

The decoder input information includes special reproduction information 114, chapter start information 115, code amount information 116, and others. Here, the special reproduction information 114 indicates fast-forwarding, rewinding, and slow reproduction. The chapter start information 115 indicates the starting point of a chapter. The code amount information 116 indicates code amount of image data.

As shown in FIG. 5C, the determination unit 21 may include the special reproduction information detection unit 25. The special reproduction information detection unit 25 detects the special reproduction information 114 in the decoder input information inputted from the decoder 24. The determination unit 21 determines the determination information 111 based on the special reproduction information 114 that has been detected. The termination instruction unit 20 outputs the termination instruction 110 to the selection unit 3 based on the determination information 111 determined based on the special reproduction information 114. This configuration allows the termination instruction unit 20 to output the termination instruction 110 for terminating the image quality adjustment according to the second embodiment, for example, when fast-forwarding or rewinding.

As shown in the example in FIG. 5D, the determination unit 21 may include a chapter start information detection unit 26. The chapter start information detection unit 26 detects the chapter start information 115 in the decoder input information inputted from the decoder 24. The determination unit 21 determines the determination information 111 based on the chapter start information 115 that has been detected. The termination instruction unit 20 outputs the termination instruction 110 to the selection unit 3 based on the determination information 111 determined based on the chapter start information 115. This configuration allows the termination instruction unit 20 to output the termination instruction 110 for terminating the image quality adjustment according to the second embodiment to the selection unit 3 when, for example, an image in the specified chapter is inputted.

As shown in the example in FIG. 5E, the determination unit 21 may include a code amount information detection unit 27. The code amount information detection unit 27 detects the code amount information 116 in the decoder input information inputted from the decoder 24. The determination unit 21 determines the determination information 111 based on the code amount information 116 that has been detected. The termination instruction unit 20 outputs the termination instruction 110 to the selection unit 3 based on the determination information 111 determined based on the code amount information 116. This configuration allows the termination instruction unit 20 to output the termination instruction 110 to the selection unit 3 for terminating the image quality adjustment according to the second embodiment, when, for example, an image having a code amount no less than a predetermined amount.

This configuration further allows termination of the image quality adjustment process when it is not necessary to adjust the image quality of the input image, and thus the process amount for adjusting image quality can be reduced.

### Third Embodiment

The image quality adjustment device according to the third embodiment is configured to determine the termination instruction shown in the second embodiment based on the obtained evaluation value.

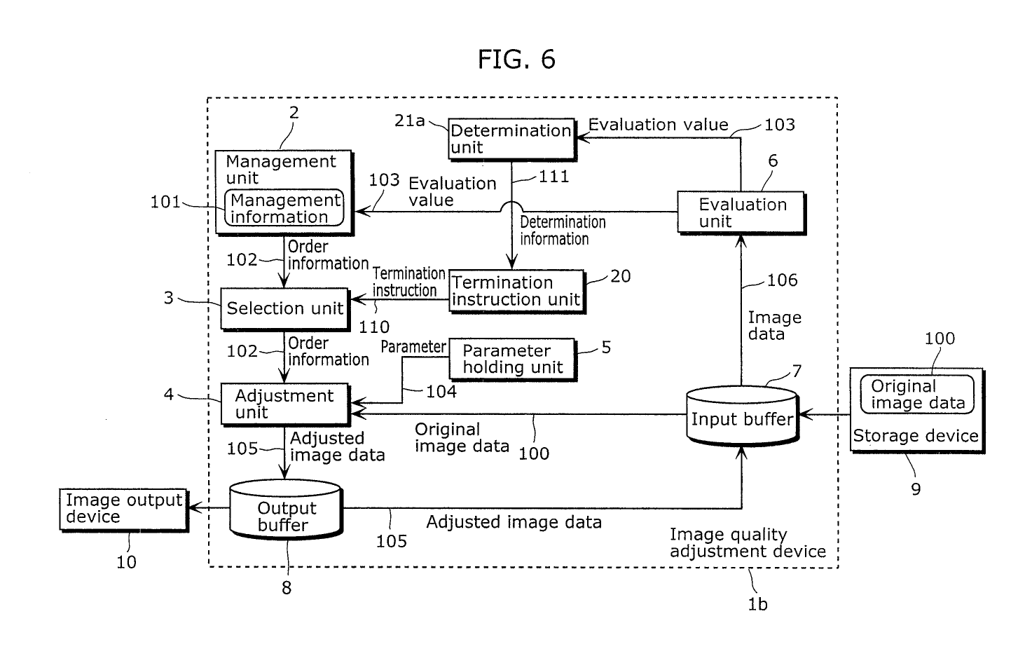

FIG. 6 is a block diagram showing the image quality adjustment device 1b according to the third embodiment. The configuration shown in FIG. 6 is different from the configuration in FIG. 4 that a determination unit 21a is added instead of the determination unit 21. Hereinafter, the description for the same components is omitted, and the description will be made focusing on the difference.

The determination unit 21a receives the evaluation value 103 from the evaluation unit 6, and outputs the determination information 111 to the termination instruction unit 20. For example, when an evaluation value exceeding the threshold is obtained, the determination unit 21a outputs the determination information 111 to the termination instruction unit 20. The termination instruction unit 20 outputs the termination instruction 110 based on the determination information 111 to the selection unit 3. The selection unit 3 selects the order information with the maximum evaluation value from among the order information having evaluation values at the time when the termination instruction is inputted, and outputs the optimal order information to the adjustment unit 4. The adjustment unit 4 adjusts image quality of the input image based on the inputted optimal order information.

This configuration allows termination of the image quality adjustment process when a sufficient evaluation value is obtained, and thus the process amount for adjusting image quality can be reduced.

In addition, the determination unit 21a may be configured to calculate a difference (increase) between the evaluation value of the adjusted image which has been adjusted using the order information that was selected first and an evaluation value of an adjusted image different from the adjusted image, and terminate the image quality adjustment process when a difference (increase) exceeding a set threshold is obtained. Note that the difference (increase) between the evaluation value of the original image data and the evaluation value of the adjusted image data may be calculated.

This configuration allows termination of the image quality adjustment process when the image quality has improved to a certain extent, and thus the process amount for adjusting image quality can be reduced.

In addition, when the evaluation values of the adjusted image data adjusted using different pieces of order information are approximately a constant value, the termination instruction unit 20 outputs the termination instruction 110 to the selection unit 3, assuming that the evaluation values of the adjusted image data do not vary regardless of the order information used.

### Fourth Embodiment

The image quality adjustment device according to the fourth embodiment is configured to determine the termination instruction shown in the second embodiment based on the obtained evaluation value.

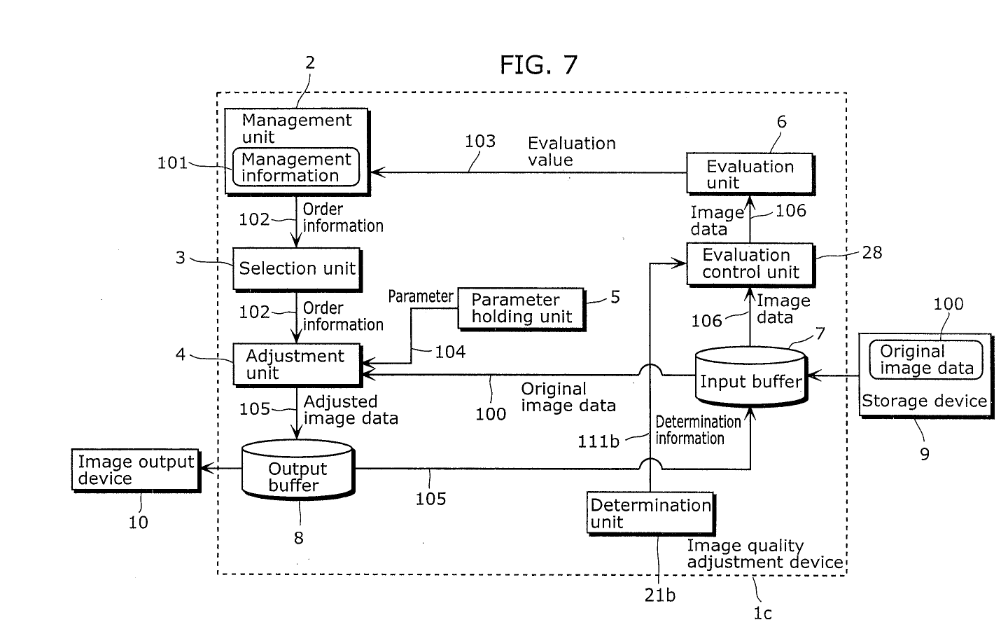

FIG. 7 is a block diagram showing the image quality adjustment device 1c according to the fourth embodiment. The configuration shown in FIG. 7 is different from the configuration shown in FIG. 4 in that an evaluation control unit 28 is added instead of the termination instruction unit 20, and a determination unit 21b is added instead of the determination unit 21. Hereinafter, the description for the same components is omitted, and the description will be made focusing on the difference.

The determination unit 21b outputs the determination information 111b for determining an image to be evaluated and an evaluation method to an evaluation control unit 28. The evaluation control unit 28 controls the image to be evaluated and the evaluation method based on the determination information 111b inputted from the determination unit 21b. The determination information 111b is, for example, information which instructs clipping image, reducing image, or switching the evaluation method.

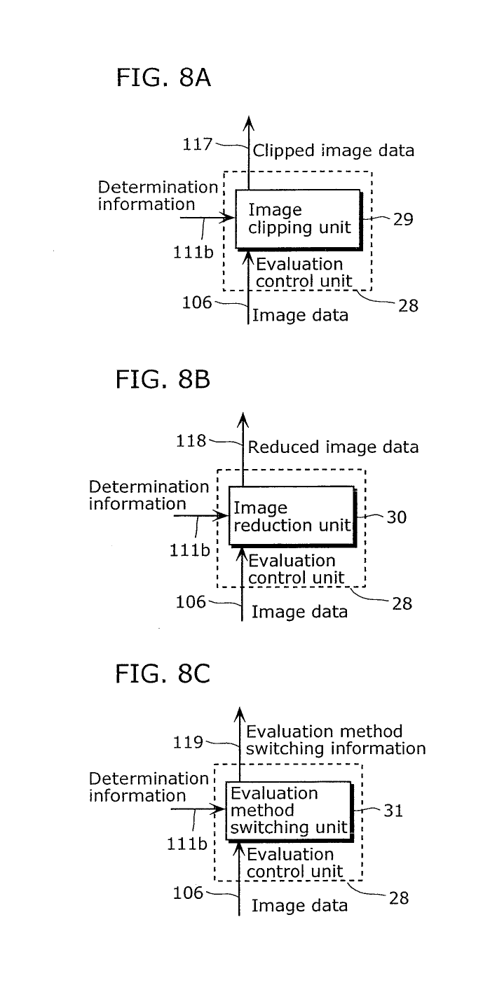

FIGS. 8A to 8C shows specific examples of the evaluation control unit 28.

As an example shown in FIG. 8A, the evaluation control unit 28 includes an image clipping unit 29. The image clipping unit 29 clips a part of the adjusted image data 105 obtained from the output buffer 8 based on the determination information 111b which includes instruction for clipping of the image, and outputs the clipped image data to the evaluation unit 6. The evaluation unit 6 evaluates the clipped image data 117 clipped by the image clipping unit 29.

With this configuration, the data amount of the clipped image is smaller than the data amount of the original image, and thus the process amount for adjusting image quality can be reduced.

In addition, as shown in the example in FIG. 8B, the evaluation control unit 28 may include the image reduction unit 30. The image reduction unit 30 reduces the adjusted image data 105 obtained from the output buffer 8 based on the determination information 111b which includes instruction for reducing the image, and outputs the reduced image data to the evaluation unit 6. The evaluation unit 6 evaluates the reduced image data 118 reduced by the image reduction unit 30.

With this configuration, the data amount of the reduced image is to be smaller than the original image, and thus the process amount for adjusting image quality can be reduced.

In addition, in the example shown in FIG. 8C, the evaluation control unit 28 includes an evaluation method switching unit 31. The evaluation method switching unit 31 outputs evaluation method switching information 119 to the evaluation unit 6 based on the determination information 111b which includes instruction for switching the evaluation methods. The evaluation unit 6 switches the evaluation method based on the evaluation method switching information 119 and evaluates the adjusted image to be evaluated. Here, the evaluation unit 6 holds at least two different evaluation methods having different levels of accuracy.

With this configuration, by switching to an evaluation method of lower accuracy, the process amount for evaluating image quality can be reduced.

The determination unit 21b determines whether or not image clipping, image reduction, and switching evaluation method is performed according to the data amount of the input image. Note that, the determination unit 21b may be configured to determine whether or not these processes are performed according to the time required for adjusting the image quality. In addition, based on the setting of the external terminal and software, the determination unit 21b may be configured to determine whether or not these processes are performed.

Furthermore, the image quality adjustment device may include the determination units 21 and 21b to control both the termination instruction unit 20 and the evaluation control unit 28 based on the determination information 111 and 111b.

### Fifth Embodiment

The image quality adjustment device according to the fifth embodiment is configured, when simultaneously adjusting image quality of images in the case of two-screen display and others, to reduce the process amount by determining similarity of the images and by sharing order information for one image for adjusting the image quality of the other image when there is a similarity.

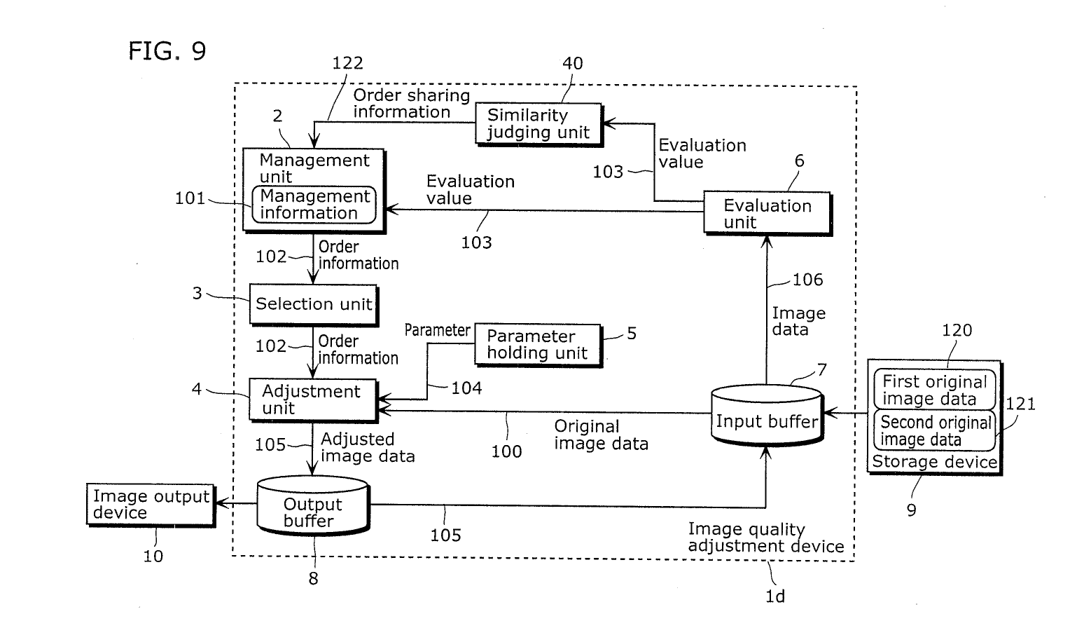

FIG. 9 is a block diagram showing the image quality adjustment device 1d according to the fifth embodiment. The configuration shown in FIG. 9 is different from the configuration shown in FIG. 1 in that the similarity judging unit 40 is added and plural images are inputted. Hereinafter, the description for the same components is omitted, and the description will be made focusing on the difference.

The similarity judging unit 40 judges, when the image quality of two pieces of original image data are simultaneously adjusted in the case of two-screen display and others, similarity between each of the input images and outputs the order sharing information 122 which indicates that the optimal order information for one input image can be shared with the other input image to the management unit 2. Here, the similarity is judged by comparing an evaluation value of the first image data and an evaluation value of the second image data.

When judging the similarity, for example, each original image data is determined to have similarity when evaluation results of the evaluation items, for example, graininess, sharpness, tonal characteristics, and color reproducibility are close, using the image quality evaluation method shown in Patent Reference 1. The evaluation result is determined to be close when a difference of the evaluation result of each of the evaluation item is equal to or less than a predetermined threshold.

The similarity judging unit 40 is usually configured of MPU, memory, and others. The processing order of each unit is implemented by software, and the software is recorded in the recording medium such as ROM. Furthermore, each unit may also be configured of hardware (a dedicated circuit).

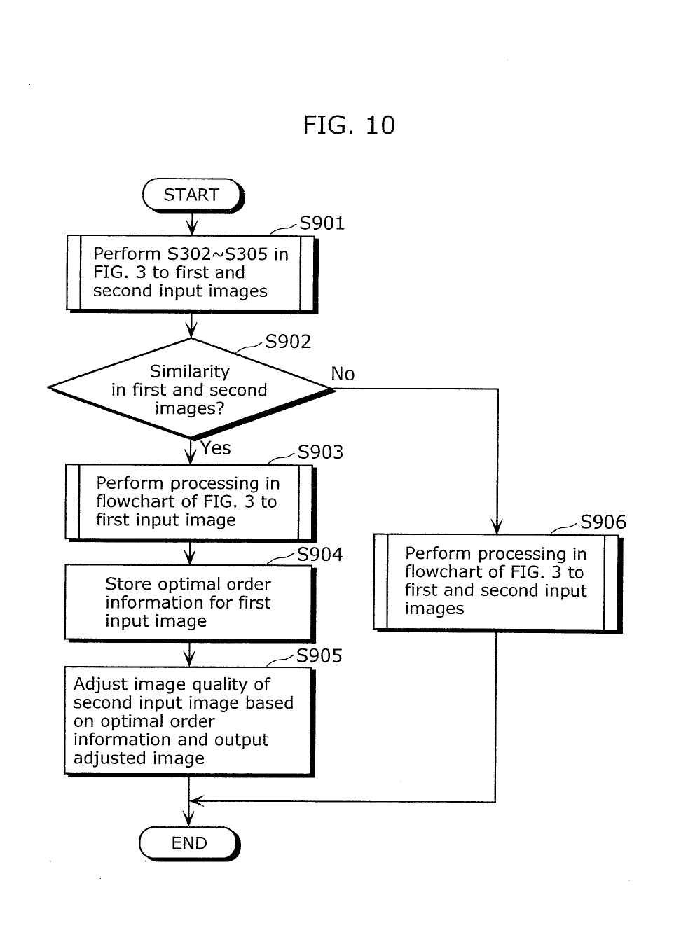

Next, the operation of the image quality adjustment device 1d is described with reference to the flowchart shown in FIG. 10.

The image quality adjustment device 1d performs processes from the order selection process (S302) shown in the flowchart in FIG. 3 to the storage process of the management information (S305) respectively, to the first original image data 120 and the second original image data 121. With this, the management unit 2 obtains the evaluation value of each of the images.

Next, the similarity judging unit 40 compares the two evaluation values obtained in the process (S901), and judges the similarity between the two original image data (S902). When it is determined that there is similarity (Yes in S902), the similarity judging unit 40 outputs the order sharing information 122 to the management unit 2.

Furthermore, the image quality adjustment device 1d performs image quality adjustment process shown in the flowchart in FIG. 3 (S301 to S308) to the first original image data 120 (S903). With this, the evaluation value and the optimal order information for the first original image data 120 is stored in the management unit 2 (S904). Here, the management unit 2 manages, when the order sharing information 122 is inputted, the evaluation value 103 obtained in the image quality adjustment process (S903) for the first original image data 120 as an evaluation value not only for the first original image data 120 but also for the second original image data 121. Accordingly, the optimal order information for the second original image data 121 is identical to the optimal order information for the first original image data 120.

The selection unit 3 selects the order information determined to be the optimal order information for the second original image data 121 in the management unit 2, and outputs the order information to the adjustment unit 4. The adjustment unit 4 adjusts image quality of the second original image data 121 based on the optimal order information that has been inputted, and outputs the adjusted image data 105 to the image output device 10 via the output buffer 8 (S905).

When it is determined that there is no similarity (No in S902), the image quality adjustment process shown in the flowchart in FIG. 3 (S301 to S308) is performed for the first original image data 120 and the second original image data 121 respectively, and outputs the adjusted image data 105 (S906).

As described above, according to the fifth embodiment, when simultaneously adjusting image quality of two pieces of original images in the case of two-screen display and others and when each piece of the original image data is judged to have a similarity, the optimal order information for the first original image data is obtained, and the optimal order information is shared for the second original image data. More specifically, it is not necessary to perform order selection process described in the first embodiment for the second original image data, and thus the process amount can be reduced.

Note that the selection unit 3 may be configured to receive the order sharing information 122. In this case, the selection unit 3 selects the optimal order information for the first original image data 120 obtained by the image quality adjustment process (S903) as the optimal order information for the second original image data 121.

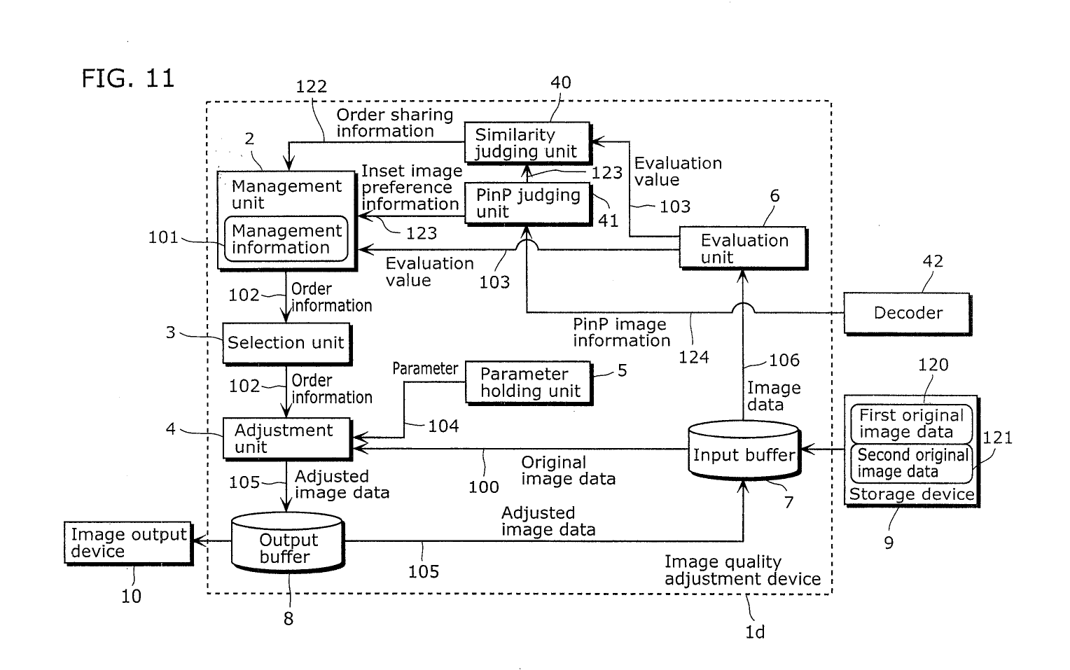

In addition, as shown in FIG. 11, the image quality adjustment device 1d according to the fifth embodiment may include a picture in picture judging unit 41. Here, a picture in picture refers to an image which includes a standard screen (parent screen) to which a small screen (child screen) is inserted. An image displayed in the parent screen is referred to as an outer image, and the image displayed in the child screen is referred to as an inset image.

The picture in picture judging unit 41 detects picture in picture image information 124 from the decoder 42, and outputs the inset image preference information 123 to the management unit 2 and the similarity judging unit 40.

The similarity judging unit 40 to which the inset image preference information 123 is inputted, identifies the inset image as the first input image and the outer image as the second input image. The management unit 2 manages the evaluation values in such a manner that the image quality of the inset image is preferentially adjusted as the first input image.

As described above, the selection unit 3 performs order selection process for the inset image via the management unit 2, however, does not perform the order selection process for the outer image. The image quality of the outer image is adjusted using the optimal order information of the inset image. When it is judged that the inset image and the outer image have a similarity, a high quality adjusted image of the outer image can be obtained.

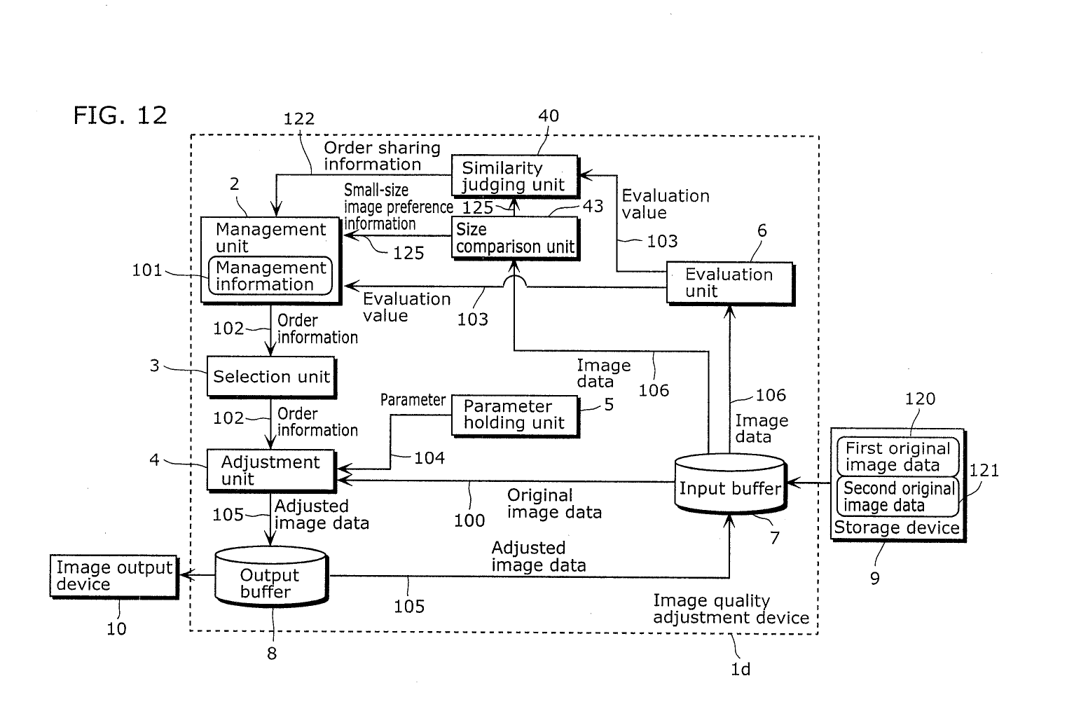

In addition, as shown in FIG. 12, the image quality adjustment device 1d according to the fifth embodiment may include a size comparison unit 43.

The size comparison unit 43 compares the image sizes of the first original image data 120 and the second original image data 121 inputted from the input buffer 7, and outputs the small-size image preference information 125 to the management unit 2 and the similarity judging unit 40.

The similarity judging unit 40 to which the small-size image preference information 125 is inputted, identifies an image which is smaller in size as the first input image and an image which is larger in size as the second input image. The management unit 2 manages the evaluation values in such a manner that the image quality of the small-size image is preferentially adjusted as the first input image.

As described above, the selection unit 3 performs order selection process for the small-size image, however, does not perform the order selection process for the large-size image. The image quality of the large-size image is adjusted using the optimal order information of the small-size image. When it is judged that the small-size image and the large-size image have a similarity, a high-quality adjusted image of the large-size image can be obtained.

This configuration allows the small-size image to be preferentially processed. When it is judged that there is a similarity, the order selection process is not necessary for the large-size image, and thus the required process amount can be reduced.

Note that the similarity judging unit 40 may judge similarity between the first original image data 120 and the second original image data 121 instead of judging the similarity between the evaluation values.

### Sixth Embodiment

First, the video reproduction apparatus according to the sixth embodiment including an image quality adjustment device is described. The video reproduction apparatus is configured to store information regarding an image of which image quality is adjusted once, and reduces the process amount for adjusting the image quality using previous image quality adjustment when outputting the image again.

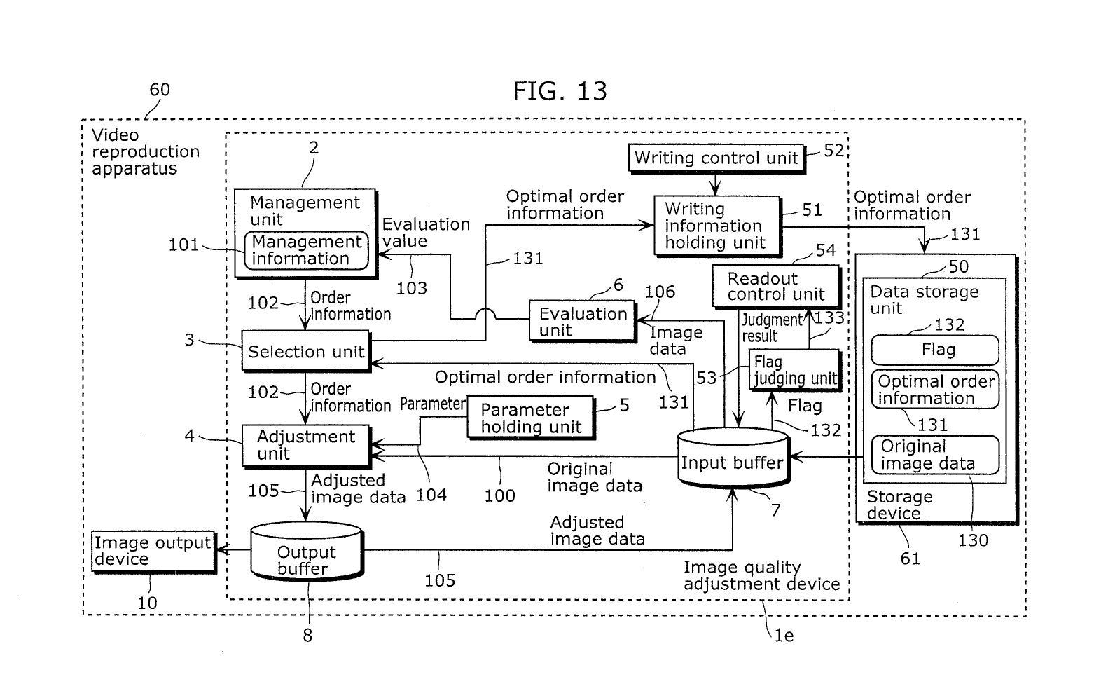

FIG. 13 is a block diagram showing an image reproduction apparatus 60 according to the sixth embodiment. The video reproduction apparatus 60 includes an image quality adjustment device 1e, a storage device 61, and an image output device 10. The image quality adjustment device 1e includes, in addition to the image quality adjustment device shown in the first embodiment, a writing information holding unit 51, a writing control unit 52, a flag judging unit 53, and a readout control unit 54. The storage device 61 includes a data storage unit 50.

The data storage unit 50 holds original image data of an input image which has been reproduced once, and associates the optimal order information 131 and the flag 132 used for the immediately previous reproduction, and store the associated the optimal order information 131 and the flag 132.

The writing information holding unit 51 holds the optimal order information 131 used for the input image which has been reproduced once.

The writing control unit 52 instructs the writing information holding unit 51 to write the content held in the writing information holding unit 51 and the flag 132 to a predetermined location in the storage device 61 when the content of the writing information holding unit 51 reaches a predetermined amount. The flag 132 indicates whether the optimal order information 131 is valid or invalid.

The flag judging unit 53 reads out the flag 132 from the input buffer 7, and judges whether the flag 132 being read out is valid or invalid. The flag judgment is performed when the image is reproduced next time (second reproduction or after).

The readout control unit 54 controls readout from the input buffer 7 based on the judgment result outputted from the flag judging unit 53. More specifically, in the case where a judgment result indicating that the flag 132 is valid, the readout control unit 54 reads out the optimal order information corresponding to the flag 132 from the input buffer 7, and outputs the optimal order information 131 that has been read out to the selection unit 3.

The writing control unit 52, the flag judging unit 53 and a readout control unit 54 is usually configured of an MPU or a memory. The processing order of each unit is implemented by software, and the software is recorded in the recording medium such as ROM. Furthermore, each unit may also be configured of hardware (a dedicated circuit).

Non-volatile recording media is suitable for the data storage unit 50 and the writing information holding unit 51.

Next, the operations of the video reproduction apparatus 60 according to the sixth embodiment are described. The video reproduction apparatus 60 according to the sixth embodiment adjusts image quality of an image, stores the obtained optimal order information to the data storage unit 50, and adjusts image quality using the optimal order information stored in the data storage unit 50. The video reproduction apparatus 60 usually performs the former operation when the video is reproduced for the first time (when the optimal order information is not associated with the original data)

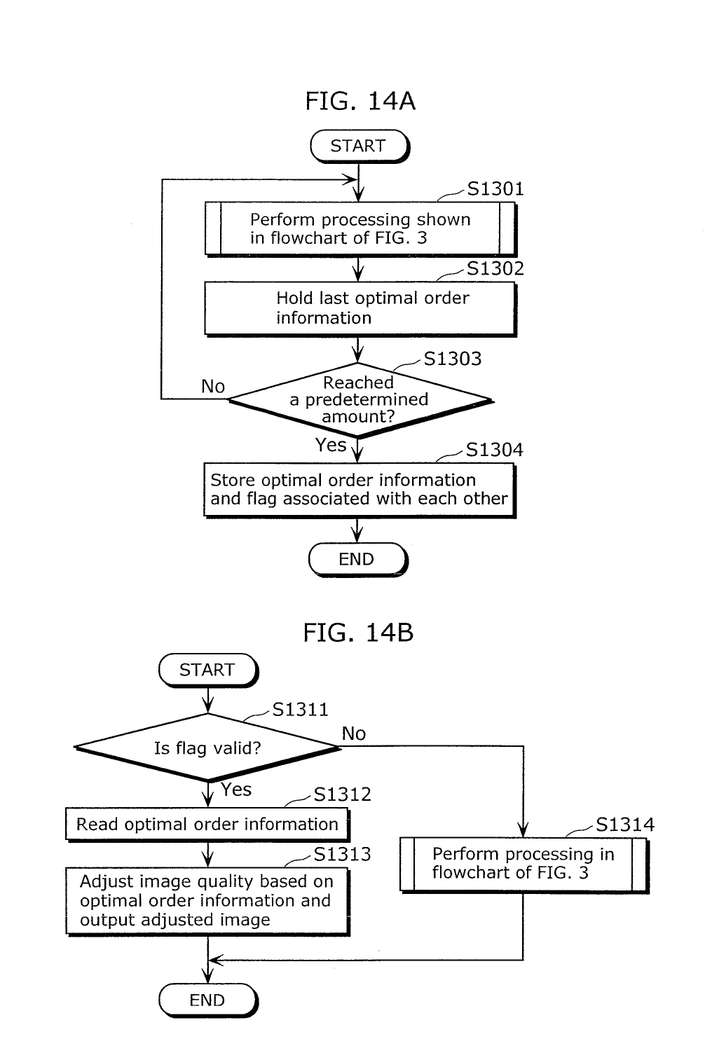

FIG. 14A is a flowchart showing the operations of the video reproduction apparatus when the input image is reproduced for the first time.

When the original image data 130 is inputted to the input buffer 7 from the storage device 61, the image quality adjustment device 1e perform image quality adjustment process on the original image data 130 according to the flowchart shown in FIG. 3 (S1301). The management unit 2 manages the optimal order information 131 after the image quality adjustment process is performed. The writing information holding unit 51 obtains the optimal order information 131 from the management unit 2 via the selection unit 3, and holds the optimal order information 131 (S1302).

The writing control unit 52 controls the writing information holding unit 51 to write the content held in the writing information holding unit 51 when the content of the writing information holding unit 51 reaches a predetermined amount (Yes in S1303), and stores the optimal order information 131 and the flag 132 in association with the original image data 130.

When the content of the writing information holding unit 51 does not reach a predetermined amount (No in S1304), the image quality adjustment device 1e continues, the image quality adjustment process shown in the flowchart in FIG. 3 (S1301).

FIG. 14B is a flowchart showing the operations of the video reproduction apparatus when the input image is reproduced next time.

The storage device 61 judges whether or not the image to be reproduced has been reproduced before. In the sixth embodiment, the storage device 61 judges whether or not the optimal order information 131 and the flag 132 are associated with the original image data 130 of the input image in the data storage unit 50.

The flag judging unit 53 reads out the flag 132 from the input buffer 7, and judges whether the flag 132 is valid or invalid (S1311). Furthermore, the flag judging unit 53 reads out the obtained judgment result and outputs the judgment result to the readout control unit 54.

When the flag 132 is valid (Yes in S1311), the readout control unit 54 reads out the optimal order information 131 from the input buffer 7, and outputs the optimal order information 131 to the selection unit 3 (S1312).

The selection unit 3 outputs the optimal order information 131 that has been read out to the adjustment unit 4. The adjustment unit 4 obtains the parameter 104 from the parameter holding unit 5 based on the inputted optimal order information 131, and performs image quality adjustment on the original image data 130. Furthermore, the adjustment unit 4 outputs the adjusted image data 105 to the image output device 10 via the output buffer 8 (S1313).

In the case where the flag 132 is invalid (No in S1311), the image quality adjustment device 1e performs image quality adjustment to the original image data 130 shown in the flowchart in FIG. 3.

As described above, with the sixth embodiment, the optimal order information 131 used when the original image data 130 is reproduced for the first time is stored, and the image quality adjustment is performed using the stored optimal order information 131 when reproducing the original image data 130 again, and thus unnecessary image quality adjustment process is reduced

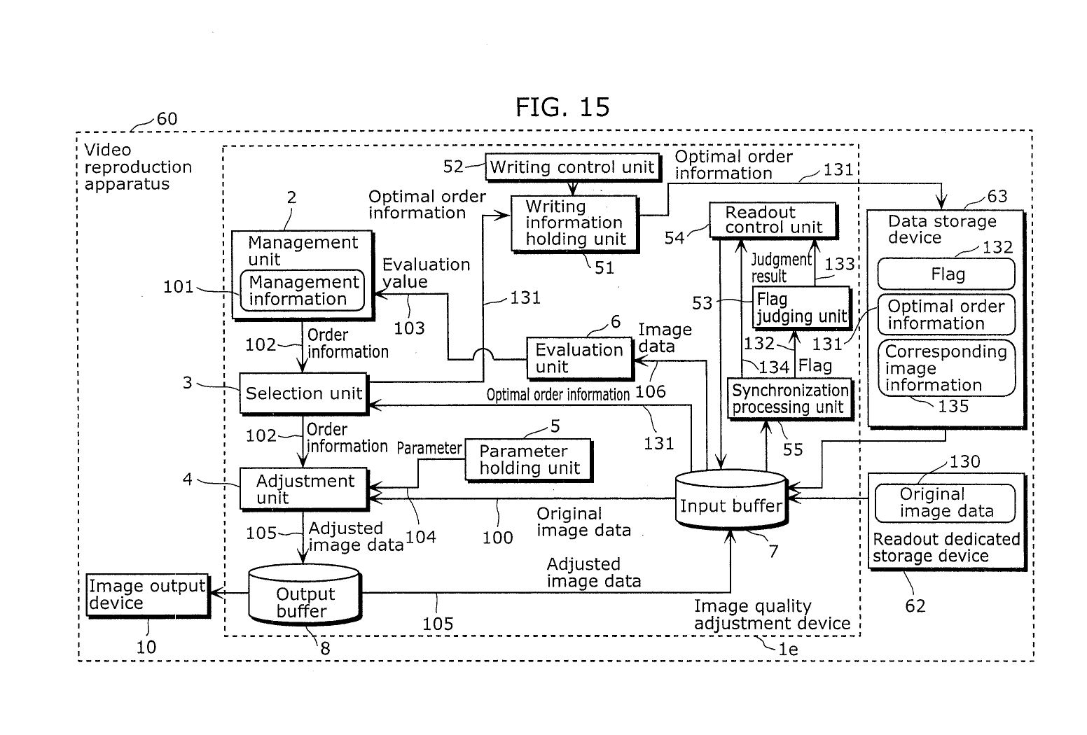

In addition, the sixth embodiment may be realized with the configuration shown in FIG. 15. The video reproduction apparatus shown in FIG. 15 is different from the apparatus shown in FIG. 13 in that a readout dedicated storage device 62 and a data storage device 63 are provided instead of the storage device 61. Furthermore, the image quality adjustment device 1e includes a synchronization processing unit 55. Hereinafter, the description for the same components is omitted, and the description will be made focusing on the difference.

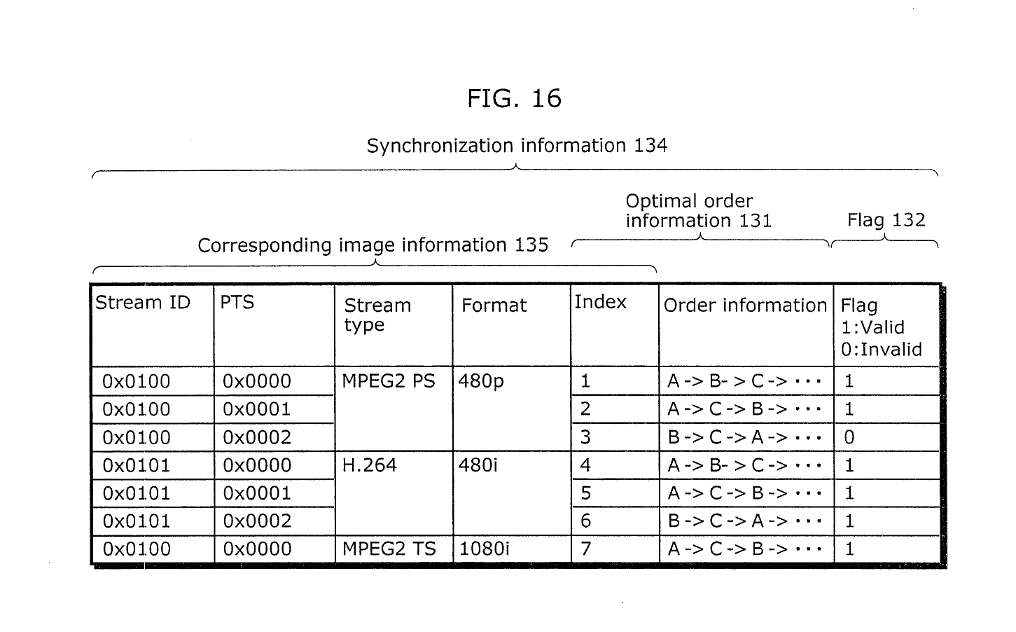

The readout dedicated storage device 62 stores the original image data 130 only. The data storage device 63 stores the optimal information 131, the flag 132, and the corresponding image information 135. Here, the corresponding image information 135 is for identifying an image such as identifiers of an image and the like, and represented in the format shown in FIG. 16.

The image quality adjustment device 1e reads the original image data 130 from the readout dedicated storage device 62 to the input buffer 7, and reads out the optimal order information 131, the flag 132, and the corresponding image information 135 from the data storage device 63 to the input buffer 7.

The synchronization processing unit 55 analyzes and synchronizes the optimal order information 131, the flag 132 and the corresponding image information 135 respectively, and notifies of the readout control unit 54 as the synchronization information 134 in the format shown in FIG. 16.

The readout control unit 54 reads the optimal order information 131 based on the judgment result 133 of the flag judging unit 53 and the synchronization information 134, and outputs the optimal order information 131 to the selection unit 3.

The selection unit 3 outputs the inputted optimal order information 131 to the adjustment unit 4. The adjustment unit 4 executes image quality adjustment on the original image data 130 based on the inputted optimal order information 131, and outputs the adjusted image data 105 to the image output device 10.

The optimal order information 131 that has been read out by the readout control unit 54 from the input buffer 7 may be inputted to the adjustment unit 4. In this case, the adjustment unit 4 adjusts image quality of the original image data 130 based on the inputted optimal order information 131.

The image quality adjustment device and the video reproduction apparatus have been described in detail above, those skilled in the art will readily appreciate that many modifications are possible in the exemplary embodiments without materially departing from the novel teachings and advantages of this invention. Accordingly, all such modifications are intended to be included within the scope of this invention.

For example, in each of the embodiments above, each process (each function) may be realized by a centralized processing by a single device (system), or may be realized by dispersed processing by multiple devices.

In addition, one computer, or more than one computer may execute the program. To put it differently, the centralized processing may be performed, or the dispersed processing may be performed.

In addition, the image quality adjustment device and the video reproduction apparatus according to the present invention can be realized, not only as a device or an apparatus, but also as a method including the processing units configuring the device or the apparatus as steps, as a program which causes a computer to execute the steps, a computer-readable recording medium such as CD-ROM on which the program is recorded, and information, data, or signal indicating the program. Furthermore, the program, information, data and signal may be distributed via a communication network such as the Internet.

### INDUSTRIAL APPLICABILITY

As described above, the image quality adjustment device according to the present invention enables execution of the image quality adjustment device in an order which optimal for the input image, and is effective for a video recording apparatus, a video reproduction apparatus and others.

What is claimed is:

1. An image quality adjustment device which adjusts image quality of an input image by applying different image quality settings to the input image, said image quality adjustment device comprising:
a management unit operable to obtain and manage pieces of order information each of which indicates an application order of the image quality settings, and evaluation values each of which corresponds to each piece of the order information and represents adequacy of the order;
a selection unit operable to select a piece of optimal order information which has a maximum evaluation value from among the pieces of order information; and
an adjustment unit operable to adjust the image quality of the input image based on the optimal order information.

2. The image quality adjustment device according to claim 1,
wherein said selection unit is further operable to perform an order selection process, prior to selecting the optimal order information, for selecting a piece of order information to which one of the evaluation values is not associated,
said adjustment unit is operable to adjust the image quality of the input image based on the selected order information,
said image quality adjustment device further comprises
an evaluation unit operable to evaluate an adjusted image generated by adjusting the image quality by said adjustment unit, and
said management unit is operable to obtain a result of the evaluation by said evaluation unit and manage the result of the evaluation as the evaluation value.

3. The image quality adjustment device according to claim 2,
wherein said selection unit is further operable to perform the order selection process until evaluation values corresponding to all of the order information are obtained.

4. The image quality adjustment device according to claim 2,
wherein said selection unit is further operable to perform the order selection process until evaluation values corresponding to a predetermined number of pieces of order information are obtained.

5. The image quality adjustment device according to claim 4, further comprising
a termination instruction unit operable to output a termination instruction to terminate the order selection process to said selection unit,
wherein said selection unit is operable to terminate the order selection process in response to the termination instruction and to select the optimal order information from among the order information that has been obtained at the time of termination.

6. The image quality adjustment device according to claim 5,
wherein said termination instruction unit is operable to output the termination instruction based on a setting of software or an external terminal.

7. The image quality adjustment device according to claim 5,
wherein said termination instruction unit is operable to output the termination instruction to said selection unit when an evaluation value of the adjusted image is inputted from said evaluation unit and the evaluation value exceeds a predetermined threshold.

8. The image quality adjustment device according to claim 5,
wherein said termination instruction unit is operable to output the termination instruction to said selection unit when an evaluation value of the adjusted image is inputted from said evaluation unit and when a difference between the evaluation value and one of the evaluation values that has been stored in said management unit exceeds a predetermined threshold.

9. The image quality adjustment device according to claim 5,
wherein said termination instruction unit is operable to output the termination instruction to said selection unit based on decoder input information inputted from a decoder.

10. The image quality adjustment device according to claim 9,
wherein the decoder input information is one of special reproduction information, chapter start information, and code amount information.

11. The image quality adjustment device according to claim 2,
wherein said evaluation unit is operable to evaluate a reduced image of the adjusted image.

12. The image quality adjustment device according to claim 2,
wherein said evaluation unit is operable to evaluate a clipped image which is an image partially clipped from the adjusted image.

13. The image quality adjustment device according to claim 2,
wherein said evaluation unit is operable to switch a first evaluation method and a second evaluation method which respectively have different levels of evaluation accuracy and to evaluate an image.

14. The image quality adjustment device according to claim 2,
wherein said management unit is operable to store, for each piece of the order information, a selection flag which indicates whether or not the order information is to be selected by said selection unit, and
said selection unit is operable to select a piece of the order information based on the selection flag.

15. The image quality adjustment device according to claim 2,
wherein the input image includes a first input image and a second input image,
said image quality adjustment device further comprises
a similarity judging unit operable to judge a similarity between an evaluation value of the first input image and at least one of evaluation values of the second input image, and to output, when the similarity is identified, order sharing information which indicates that the order information can be shared, and
said management unit is operable to associate the evaluation value of the first input image with the evaluation value of the second input image when the order sharing information is inputted.

16. The image quality adjustment device according to claim 15, further comprising
a size comparison unit operable to compare sizes of two input images, and to determine an image which is smaller in size as the first input image and an image which is larger in size as the second input image,
wherein said selection unit is further operable to perform the order selection process for the first input image, and not to perform the order selection process for the second input image.

17. The image quality adjustment device according to claim 15, further comprising
a picture-in-picture judging unit operable to detect a picture-in-picture image, and to determine an inset image of the picture-in-picture image as the first input image and an outer image of the picture-in-picture image as the second input image,
wherein said selection unit is operable to perform the order selection process for the first input image, and not to perform the order selection process for the second input image.

18. The image quality adjustment device according to claim 2,
wherein the input image includes a first input image and a second input image,
said image quality adjustment device further comprises
a similarity judging unit operable to judge a similarity between an evaluation value of the first input image and at least one of evaluation values of the second input image, and to output when the similarity is identified, order sharing information which indicates that order information can be shared, and
said selection unit is operable to select optimal order information for the first input image based on the order sharing information when adjusting the image quality of the second input image.

19. A video reproduction apparatus which reproduces an image adjusted by an image quality adjustment device including:
a storage device in which image data is stored; and
the image quality adjustment device which adjusts image quality of an input image inputted from said storage device by applying different image quality settings to the input image,
wherein said image quality adjustment device including:
a management unit operable to obtain and manage pieces of order information each of which indicates an application order of the image quality settings, and evaluation values each of which corresponds to each piece of the order information and represents adequacy of the order;
a selection unit operable to select a piece of optimal order information which has a maximum evaluation value from among the pieces of order information, and further operable to perform an order selection process, prior to selecting the optimal order information, for selecting a piece of order information to which one of the evaluation values is not associated;
an adjustment unit operable to adjust the image quality of the input image based on the selected order information, and further operable to adjust, when the optimal order information is selected, the image quality of the input image based on the selected optimal order information; and
an evaluation unit operable to evaluate an adjusted image generated by adjusting the image quality by the adjustment unit, and
the management unit is operable to obtain a result of the evaluation by the evaluation unit and manage the result of the evaluation as the evaluation value, said video reproduction apparatus comprises:
a data storage unit operable to store a flag which indicates whether optimal order information used in a previous reproduction is valid or invalid and the optimal order information;
a writing information holding unit operable to hold the optimal order information notified by said selection unit; and
a writing control unit operable to control said writing information holding unit to store the content held by said writing information holding unit and the flag in a predetermined location in said data storage unit when the content held by said writing information holding unit reaches a predetermined amount.

20. The video reproduction device according to claim 19, further comprising:
a flag judging unit operable to read out the flag from said data storage unit and to judge whether the flag is valid or invalid; and
a readout control unit operable to receive a result of the judgment by said flag judging unit, and to read out the optimal order information from said data storage unit when the flag is valid.

21. The video reproduction device according to claim 20,
wherein said data storage unit is included in the storage device and operable to store the flag and the optimal order information in association with a reproduced image, and
said flag judging unit is operable to read out the flag corresponding to the image being reproduced when reproducing a new image, and to judge whether the flag is valid or invalid.

22. The video reproduction device according to claim 20,
wherein said data storage unit is further operable to store synchronization information which indicates the optimal order information is to be synchronized with the image, and
said readout control unit is further operable to read out the optimal order information while synchronizing the optimal order information to the input image inputted to the image quality adjustment device based on the synchronization information.

23. An image quality adjustment method for adjusting image quality of an input image by applying different image quality settings to the input image, said image quality adjustment method comprising:
obtaining and managing pieces of order information each of which indicates an application order of the image quality settings, and evaluation values each of which corresponds to each piece of the order information and represents adequacy of the order;
selecting a piece of optimal order information which has a maximum evaluation value from among the pieces of order information; and
adjusting the image quality of the input image based on the optimal order information.

24. A program product which, when loaded into a computer, allows a computer to execute an image quality adjustment method for adjusting image quality of an input image by applying different image quality settings to the input image, said program causing the computer to execute:
obtaining and managing pieces of order information each of which indicates an application order of the image quality settings, and evaluation values each of which corresponds to each piece of the order information and represents adequacy of the order;
selecting a piece of optimal order information which has a maximum evaluation value from among the pieces of order information; and
adjusting the image quality of the input image based on the optimal order information.

25. A computer-readable recording medium, in which a program for causing a computer to execute an image quality adjustment method for adjusting image quality of an input image by applying different image quality settings to the input image,
wherein the program includes:
obtaining and managing pieces of order information each of which indicates an application order of the image quality settings, and evaluation values each of which corresponds to each piece of the order information and represents adequacy of the order;
selecting a piece of optimal order information which has a maximum evaluation value from among the pieces of order information; and
adjusting the image quality of the input image based on the optimal order information.
